(19) United States
(12) Patent Application Publication
(10) Pub. No.: US 2015/0116303 A1
(43) Pub. Date: Apr. 30, 2015

(54) DISPLAY DEVICE AND DRIVING METHOD THEREOF

(71) Applicant: SAMSUNG DISPLAY CO., LTD., Yongin-City (KR)

(72) Inventors: Ji-Gong Lee, Yongin-City (KR); Jin-Woo Park, Yongin-City (KR); Hideo Yoshimura, Yongin-City (KR)

(21) Appl. No.: 14/525,079

(22) Filed: Oct. 27, 2014

(30) Foreign Application Priority Data
Oct. 30, 2013 (KR) 10-2013-0129720

(51) Int. Cl. G09G 3/20; G09G 3/32; G09G 3/36; G09G 3/28

(52) U.S. Cl. CPC G09G 3/20; G09G 3/28; G09G 3/3208; G09G 3/36; G09G 2310/0272; G09G 2310/0289
USPC 345/212

(57) ABSTRACT

A display device includes: pixels at areas defined by gate lines and data lines; a gate driver configured to selectively drive the gate lines; a data driver configured to generate data signals set to various voltages, using data to be supplied to the gate lines, and to supply the data signals to the data lines; a timing controller configured to control the gate driver and the data driver; and an order setting unit configured to set a driving order of the gate lines by comparing information values of the gate lines.

### CROSS-REFERENCE TO RELATED APPLICATION

This application claims priority to and the benefit of Korean Patent Application No. 10-2013-0129720, filed on Oct. 30, 2013, in the Korean Intellectual Property Office, the entire contents of which are incorporated herein by reference in their entirety.

### BACKGROUND

1. Field

Aspects of embodiments of the present invention relate to a display device and a driving method thereof.

2. Description of the Related Art

With the development of information technologies, the demand for a display that is a connection medium for information has increased. Accordingly, flat panel display devices (FPDs) such as liquid crystal display devices (LCDs), organic light emitting display devices (OLEDs), and plasma display panels (PDPs) are increasingly used.

### SUMMARY

Aspects of embodiments of the present invention provide a display device and a driving method thereof.

According to an aspect of embodiments of the present invention, a display device includes: pixels at areas defined by gate lines and data lines; a gate driver configured to selectively drive the gate lines; a data driver configured to generate data signals set to various voltages, using data to be supplied to the gate lines, and to supply the data signals to the data lines; a timing controller configured to control the gate driver and the data driver; and an order setting unit configured to set a driving order of the gate lines by comparing information values of the gate lines.

The information values of the data may be voltage values of data signals corresponding to the data.

The display device may further include a lookup table configured to store the voltage values of the data signals corresponding to bits of the data.

The information values of the data may be gray level values corresponding to the bits of the data.

The gray levels may be divided into groups each including multiple ones of the gray level values, wherein natural numbers are assigned to corresponding ones of the groups in a sequentially increasing order.

The order setting unit may be configured to: detect similarities between the information values of the data supplied to other gate lines of the gate lines, based on information values of the data supplied to a first gate line of the gate lines; and select a next gate line of the gate lines to which a next scan signal is to be supplied, wherein the next gate line has high similarity information values compared to the information values of the data supplied to the first gate line.

When the similarity values are detected, the order setting unit may be configured to: obtain difference values between the information values of the data corresponding to a same data line of the data lines as the unit of the gate lines, based on the information values of the data supplied to the first gate line; and extract similarity values by calculating a square of the difference values and calculating a sum of the square of the difference values as the unit of the gate lines.

The order setting unit may be configured to select whichever one of the gate lines has a smallest similarity value for supplying the next scan signal.

The order setting unit may be configured to select one of the gate lines that is arranged physically close to one of the first gate line to supply the next scan signal when a plurality of gate lines having a smallest similarity value exist.

The order setting unit may be configured to set the driving order of all the gate lines by performing a similarity test on the gate lines, based on a specific gate line of the gate lines after the specific gate line is selected.

The first gate line may be at a first horizontal line.

The order setting unit may be configured to: sequentially extract similarity values with the information values of the data supplied to other gate lines of the gate lines, based on the information values of the data supplied to a first gate line of the gate lines; and select a specific gate line of the gate lines to which a next scan signal is to be supplied when the similarity value of the specific gate line of the gate lines is equal to or smaller than a reference value.

When the specific gate line is selected, the order setting unit may be configured to: stop extracting the similarity values based on the first gate line; and concurrently extract other similarity values with respect to the other gate lines of the gate lines, based on the specific gate line.

The gate lines may be divided into a plurality of groups, and the order setting unit may be configured to perform a similarity test by comparing the information values of the data with respect to one gate line of the gate lines in each group.

An order in which a gate signal is to be supplied may be determined for each group according to the similarity test.

A scan signal may be sequentially supplied to the gate lines in a same group.

The gate lines may be divided into a plurality of groups, and the order setting unit may be configured to perform a similarity test by comparing the information values of the data as a unit of gate lines of the gate lines in a corresponding group with respect to each of the groups.

The order setting unit may be configured to set a next driving order of a next group of the groups after setting the driving order of gate lines with respect to one group of the groups.

The order setting unit may be configured to start setting the driving order of the gate lines with respect to the next group, based on the information values of the data corresponding to a selected gate line of the gate lines of a completed group of the groups where the driving order of the gate lines has already been set.

The order setting unit may be configured to: generate a gate driving control signal corresponding to the driving order of the gate lines; and supply the gate driving control signal to the gate driver.

The gate driver may include a decoder configured to select one of the gate lines by outputting a scan signal corresponding to the gate driving control signal.

The display device may further include a data storage unit configured to store the data.

According to aspects of embodiments of the present invention, in a method of driving a display device, the method includes: setting a first gate line as a reference among a plurality of gate lines; comparing information values of data assigned to the first gate line with information values of data assigned to other ones of the gate lines to calculate a compared result; and selecting a second gate line of the gate lines to which a next scan signal is to be supplied, corresponding to the compared result, wherein the information values of the data comprise voltage values of data signals to be supplied by the data or gray level values of the data.

Whenever a driving order with respect to one of the gate lines is set, the one of the gate lines having the set driving order may be designated a reference gate line, and the driving order of remaining ones of the gate lines may be set by comparing the information values of the data corresponding to the reference gate line with the information values of the data assigned to the remaining ones of the gate lines.

The method may further include supplying a data signal of the data signals to the data lines according to the driving order of the gate lines.

Comparing the information values of the data assigned to the gate lines may further include: obtaining difference values between the information values of the data corresponding to a same data line as a unit of gate lines, based on the information values of the data supplied to the first gate line; and extracting similarity values by calculating a square of the difference values and calculating a sum of the square of the difference values as the unit of the gate lines.

Selecting the second gate line may further include selecting one of the gate lines that has a smallest similarity value.

Comparing the information values of the data assigned to the first gate line with the information values of the data assigned to the other ones of the gate lines may further include selecting a corresponding gate line of the gate lines as the second gate line when the similarity value of the corresponding gate line is equal to or lower than a reference value.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be more thorough and more complete, and will more fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a circuit diagram illustrating an embodiment of a pixel in an organic light emitting display device.

FIG. 2 is a diagram illustrating a display device according to an embodiment of the present invention.

FIGS. 3A to 3C are diagrams illustrating an embodiment of a method of determining a driving order of gate lines.

FIG. 4 is a flowchart illustrating a method of setting a driving order of gate lines according to an embodiment of the present invention.

FIG. 5 is a flowchart illustrating a method of setting a driving order of gate lines according to another embodiment of the present invention.

FIG. 6 is a diagram illustrating a display device according to another embodiment of the present invention.

FIG. 7 is a diagram illustrating another embodiment of a method of determining a driving order of gate lines.

FIG. 8 is a flowchart illustrating a method of setting a driving order of gate lines according to still another embodiment of the present invention.

FIG. 9 is a flowchart illustrating a method of setting a driving order of gate lines according to still another embodiment of the present invention.

### DETAILED DESCRIPTION

Hereinafter, certain example embodiments according to the present invention will be described with reference to the accompanying drawings. Here, when a first element is described as being coupled to a second element, the first element may be directly coupled to the second element or may be indirectly coupled to the second element via a third element. Further, some of the elements that are not essential to the complete understanding of the invention are omitted for clarity. Also, like reference numerals refer to like elements throughout.

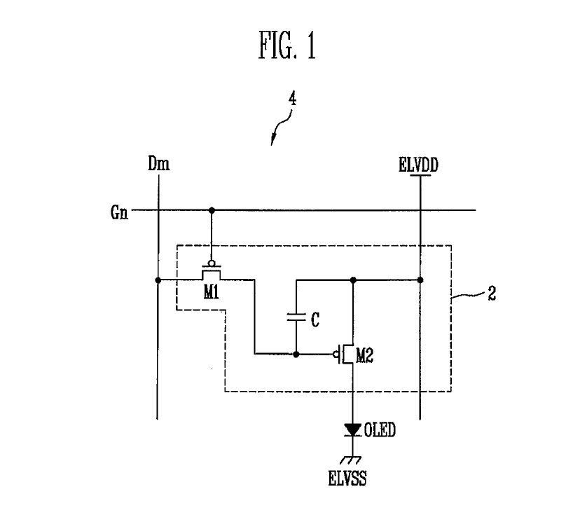

FIG. 1 is a circuit diagram illustrating an embodiment of a pixel in an organic light emitting display device.

Referring to FIG. 1, the pixel 4 of the organic light emitting display device includes an organic light emitting diode OLED, and a pixel circuit 2 coupled to a gate line Gn and a data line Dm to control the organic light emitting diode OLED.

An anode electrode of the organic light emitting diode OLED is coupled to the pixel circuit 2, and a cathode electrode of the organic light emitting diode OLED is coupled to a second power source ELVSS. The organic light emitting diode OLED emits light, corresponding to current supplied from the pixel circuit 2.

The pixel circuit 2 receives a data signal supplied from the data line Dm when a scan signal is supplied to the gate line Gn, and controls the amount of current supplied to the organic light emitting diode OLED, corresponding to the receive data signal. To this end, the pixel circuit 2 includes a second transistor M2 coupled between a first power source ELVDD and the organic light emitting diode OLED, a first transistor M1 coupled among the second transistor M2, the data line Dm and the gate line Gn, and a storage capacitor C coupled between a gate electrode of the second transistor M2 and the first power source ELVDD.

A gate electrode of the first transistor M1 is coupled to the gate line Gn, and a first electrode of the first transistor M1 is coupled to the data line Dm. A second electrode of the first transistor M1 is coupled to the gate electrode of the second transistor M2. The first transistor M1 is turned on when the scan signal is supplied to the gate line Gn, to supply the data signal supplied from the data line Dm to the gate electrode of the second transistor M2. In this case, the storage capacitor C charges a voltage corresponding to the data signal. The first electrode is set as any one of source and drain electrodes, and the second electrode is set as an electrode different from the first electrode. For example, if the first electrode is set as the source electrode, the second electrode is set as the drain electrode.

A first electrode of the second transistor M2 is coupled to one terminal of the storage capacitor C and the first power source ELVDD, and a second electrode of the second transistor M2 is coupled to the anode electrode of the organic light emitting diode OLED. The gate electrode of the second transistor M2 is coupled to the other terminal of the storage capacitor C and the second electrode of the first transistor M1. The second transistor M2 controls the amount of current flowing from the first power source ELVDD to the second power source ELVSS via the organic light emitting diode OLED, corresponding to the voltage stored in the storage capacitor C.

In the organic light emitting display device using an analog driving method, the pixel 4 receives a data signal supplied through the data line Dm. Here, the data signal is set to various voltage values, corresponding to gray levels. The pixel 4 receiving the data signal expresses a gray level while controlling the amount of the current supplied to the organic light emitting diode OLED.

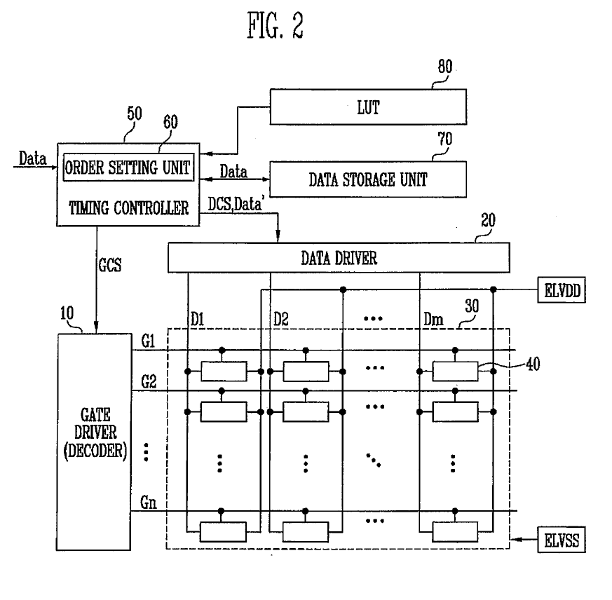

In the analog driving method, a scan signal is sequentially supplied to gate lines G during a frame period, and a data signal is supplied to data lines D to be synchronized with the scan signal. Because the data signal supplied to the data lines D is changed corresponding to a gray level, the voltage in each data line D is changed every horizontal period, and therefore, high amount of power is consumed. For example, because the capacitance of data lines increases as a display panel becomes large in size and high in resolution, the power consumption also increases. Accordingly, according to embodiments of the present invention, there is provided a driving device and method for reducing power consumption while implementing a display device in an analog driving method. This will be described in some detail with reference to FIGS. 2 to 9.

FIG. 2 is a diagram illustrating a display device according to an embodiment of the present invention.

Referring to FIG. 2, the display device according to this embodiment includes a pixel unit 30 including pixels respectively positioned in areas defined by gate lines G1 to Gn and data lines D1 to Dm, a gate driver 10 configured to selectively drive the gate lines G1 to Gn, a data driver 20 configured to supply, to the data lines D1 to Dm, a data signal corresponding to a gate line G to which a current scan signal is supplied among the gate lines G1 to Gn, and a timing controller 50 configured to control the gate driver 10 and the data driver 20.

The display device according to this embodiment further includes an order setting unit 60 configured to set a driving order of the gate lines G1 to Gn by comparing data for each gate line (i.e., for each horizontal line), a data storage unit 70 configured to store a data Data, and a look-up table 80 (hereinafter, referred to as an “LUT”) configured to store the voltage of a data signal corresponding to the data Data.

The gate driver 10 selectively drives the gate lines G1 to Gn while supplying a scan signal to the gate lines G1 to Gn. The supply order of the scan signal in the gate driver 10 is determined by a gate driving control signal GCS supplied from the order setting unit 60. To this end, the gate driver 10 is designed to freely change the driving order of the gate lines G1 to Gn. For example, the gate driver 10 may be implemented as a decoder which can non-sequentially output the scan signal, corresponding to the gate driving control signal GCS.

The data driver 20 receives a data Data′ rearranged in the order setting unit 60, and generates a data signal, using the received data Data′. The data driver 20 generating the data signal supplies the data signal to the data lines D1 to Dm to be synchronized with the scan signal supplied to the gate lines G1 to Gn. Here, the rearranged data Data′ means a data corresponding to a gate line which receives a current scan signal. The data driver 20 receives gamma voltages supplied from a gamma voltage unit (not shown) in order to generate the data signal.

The pixel unit 30 receives a first power source ELVDD, a second power source ELVSS, a scan signal and a data signal, supplied from an outside thereof, and displays an image corresponding to the first power source ELVDD, the second power source ELVSS, the scan signal and the data signal. Here, each pixel 40 expresses a gray level while controlling the amount of current supplied to the organic light emitting diode OLED, corresponding to the voltage of the data signal.

The LUT 80 stores the voltage value of a data signal corresponding to bits of the data Data. More specifically, the data driver 20 supplies a data signal set to various voltages, corresponding to the bits of the data Data. The LUT 80 stores the voltage of a data signal to be supplied from the data driver 20, corresponding to the bits of the data Data.

The timing controller 50 generates a gate driving control signal GCS and a data driving control signal DCS, corresponding to synchronization signals supplied from an outside thereof. The gate driving control signal GCS generated in the timing controller 50 is supplied to the gate driver 10, and the data driving control signal DCS generated in the timing controller 50 is supplied to the data driver 20.

The timing controller 50 includes the order setting unit 60 configured to set a driving order of the gate lines G1 to Gn and rearrange a data Data, corresponding to the set driving order. The order setting unit 60 sets a driving order of the gate lines G1 to Gn so that power consumption is reduced, and generates a gate driving control signal GCS corresponding to the set driving order and then the generated gate driving control signal GCS to the gate driver 10. The order setting unit 60 rearranges a data Data, corresponding to the driving order of the gate lines G1 to Gn, and supplies the rearranged data Data′ together with the data driving control signal DCS to the data driver 20.

For example, the order setting unit 60 may compare the voltage of a data signal corresponding to the data Data for each gate line (each horizontal line), and set the driving order of the gate lines G1 to Gn so that power consumption can be reduced corresponding to the compared result. For example, the order setting unit 60 extracts, from the LUT 80, a voltage corresponding to the data Data stored in the data storage unit 70, and sets the driving order of the gate lines G1 to Gn while comparing the extracted voltage for each gate line. Here, the order setting unit 60 sets the driving order of the gate line G1 to Gn so that the power consumption can be reduced by minimizing the voltage difference between the data lines D1 to Dm.

To this end, the order setting unit 60 performs a similarity test of data Data for each gate line G, and sets the driving order of the gate lines G1 to Gn so that data Data having high voltage similarity can be consecutively supplied.

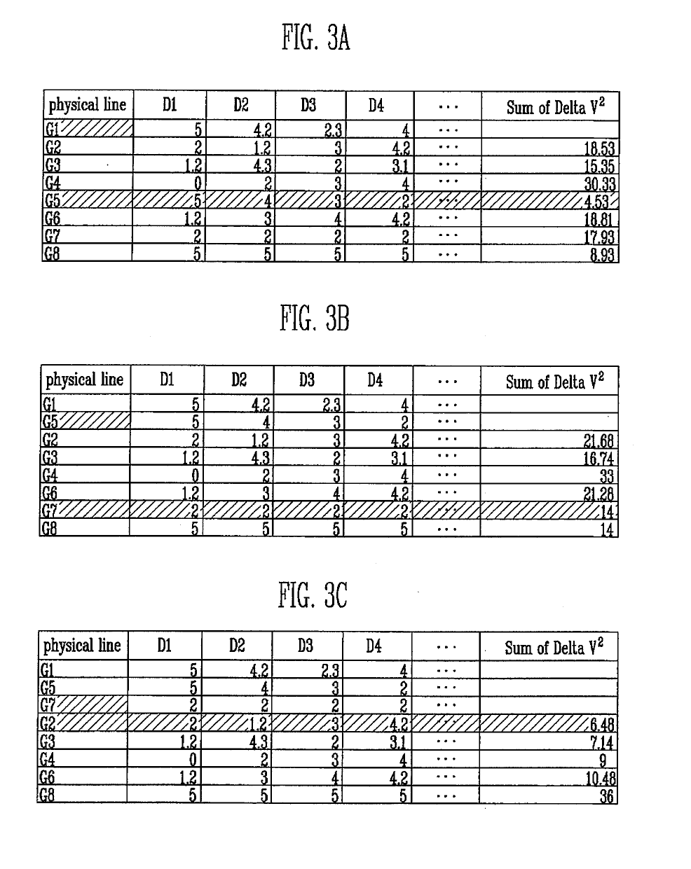

FIGS. 3A to 3C are diagrams illustrating an embodiment of a method of determining a driving order of gate lines. For convenience of illustration, eight gate lines G1 to G8 will be shown in FIGS. 3A to 3C.

Referring to FIGS. 3A to 3C, G1 to G8 mean gate lines, and D1 to D4 means data lines. “5” positioned at the intersection portion of D1 and G5 means the voltage of a data signal to be supplied to the data line D1.

First, FIG. 3A shows voltages of data signals to be supplied to data lines D1 to D4 corresponding to gate lines G1 to G8, based on a physical arrangement order. Actually, data Data are stored in the data storage unit 70, corresponding to an input order, i.e., a physical arrangement order of the gate lines G1 to G8.

The order setting unit 60 extracts a voltage value from the LUT 80, corresponding to bits of the data Data stored in the data storage unit 70, thereby generating a table of FIG. 3A. Here, if a data signal is supplied to the data lines D1 to D4 while sequentially supplying a scan signal to the gate lines G1 to G8 as shown in FIG. 3A, without setting any order, high power is consumed by a voltage change of the data lines D1 to D4. Accordingly, the order setting unit 60 sets the driving order of the gate lines G1 to G8 so that a data signal having high voltage similarity is supplied by comparing the voltage values of data signals as a unit of the gate lines G1 to G8.

For example, the order setting unit 60 first selects one gate line to become a reference among the plurality of gate lines G1 to G8. For example, the order setting unit 60 may set a first gate line G1 as a reference gate line. Here, the reference gate line is a gate line which first receives a scan signal.

After the first gate line G1 is set as the reference gate line, the order setting unit 60 compares the voltage of a data signal corresponding to the first gate line G1 with the voltages of data signals corresponding to the other gate lines G2 to G8. Here, the power is in proportion to the square of voltage (V²). Hence, the voltages of data signals corresponding to a comparison gate line are respectively subtracted from the voltages of data signals corresponding to the reference gate line G1, and each of the subtracted voltages is then squared. Subsequently, the squared values are summed, thereby obtaining a similarity value. For example, difference values between voltages assigned to the same data line are obtained as a unit of gate lines, and each of the obtained difference values is then squared. Subsequently, the squared values are summed, thereby obtaining a similarity value (Sum of Delta V²: here, Delta means a difference value).

A process of performing a similarity test on the first and second gate lines G1 and G2 will be described in some detail. First, “9” is obtained corresponding to 5−2=3², “9” is obtained corresponding to 4.2−1.2=3², “0.49” is obtained corresponding to 2.3−3=−0.7², and “0.04” is obtained corresponding to 44.2=−0.2². Subsequently, 9, 9, 0.49 and 0.04 are summed up, thereby obtaining a similarity value of “18.53”. Similarly, a similarity value of “15.35” is obtained corresponding to a similarity test of the first and third gate lines G1 and G3, a similarity value of “30.33” is obtained corresponding to a similarity test of the first and fourth gate lines G1 and G4, a similarity value of “4.53” is obtained corresponding to a similarity test of the first and fifth gate lines G1 and G5, a similarity value of “18.81” is obtained corresponding to a similarity test of the first and sixth gate lines G1 and G6, a similarity value of “17.93” is obtained corresponding to a similarity test of the first and seventh gate lines G1 and G7, and a similarity value of “8.93” is obtained corresponding to a similarity test of the first and eighth gate lines G1 and G8.

After the similarity values of the other gate lines G2 to G8 corresponding to the first gate line G1 are determined, the order setting unit 60 selects the gate line having the smallest similarity value, i.e., the fifth gate line G5 as a gate line to be driven next time as shown in FIG. 3B. Here, that the similarity value is small means that relatively low power is consumed by minimizing or reducing a change in voltage, caused by the data signal.

Subsequently, the voltages of data signals corresponding to the other gate lines G2 to G4 and G6 to G8 are compared based on the selected fifth gate line G5. In similarity test processes of the fifth gate line G5 and the other gate lines G2 to G4 and G6 to G8, a similarity value of “21.68” is obtained corresponding to the similarity test of the second gate line G2, a similarity value of “16.74” is obtained corresponding to the similarity test of the third gate line G3, a similarity value of “33” is obtained corresponding to the similarity test of the fourth gate line G4, a similarity value of “21.28” is obtained corresponding to the similarity test of the sixth gate line G6, a similarity value of “14” is obtained corresponding to the similarity test of the seventh gate line G7, and a similarity value of “14” is obtained corresponding to the similarity test of the eighth gate line G8.

After the similarity values of the other gate lines G2 to G4 and G6 to G8 corresponding to the fifth gate line G5, the gate line having the smallest similarity value is selected as a gate line to be driven next time. In FIG. 3B, the similarity values of the seventh and eighth gate lines G7 and G8 are equally set to “14”. In this case, the order setting unit 60, as shown in FIG. 3C, selects the second gate line G7 positioned physically close to the fifth gate line G5 which becomes the reference as a gate line to be driven next time. Subsequently, similarity test processes of the seventh gate line G7 and the other gate lines G2 to G4, G6 and G8 are performed, and the driving order of the gate lines G2 to G4, G6 and G8 is determined corresponding to the performed result.

That is, whenever a driving order with respect to one gate line is set, the order setting unit 60 changes the gate line of which driving order is set into a gate line, which becomes the reference, and compares the voltage of a data signal corresponding to the gate line with the voltages of data signals corresponding to the other gate lines of which driving orders are not set, thereby setting a gate line to be driven next time. Thus, the order setting unit 60 determines the driving order of all the gate lines G by repeating the process described above. Here, the gate line, which initially becomes the reference, may be arbitrarily set. For example, the first gate line G1 positioned on the first horizontal line is arranged as a line, which becomes a first reference, thereby setting the driving order of the other gate lines.

The order setting unit 60 rearranges data Data so that the data signal is supplied to pixels coupled to a corresponding gate line G through the data lines D1 to D4, corresponding to the order of the gate lines G1 to G8, and supplies the rearranged data Data′ to the data driver 20.

Additionally, the order setting unit 60 may perform the similarity test, using two methods.

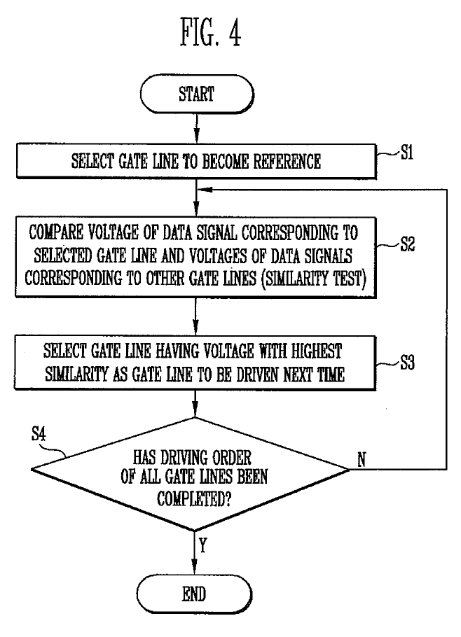

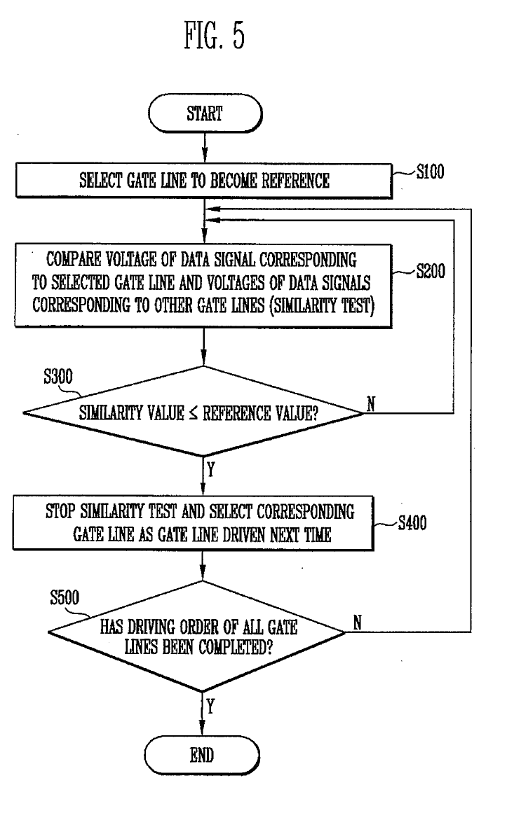

In one method, if one reference gate line is set, the voltage of a data signal corresponding to the gate line, which becomes the reference, is compared with the voltages of data signals corresponding to the other gate lines of which driving orders are not determined, thereby extracting similarity values, and the gate line having the smallest similarity value is set as a gate line to be driven next time. The method will be described in some detail later with reference to FIG. 4.

The other method is a method of previously setting a reference value with respect to similarity. In this case, the voltage of a data signal corresponding to a reference gate line is sequentially compared with the voltages of data signals corresponding to the other gate lines, thereby extracting similarity values. In a case where the extracted similarity value is equal to or smaller than the reference value, the similarity test on the other gate lines is stopped, and the gate line having the similarity value extracted therefrom is set as a gate line to be driven next time. The method will be described in more detail later with reference to FIG. 5.

In embodiments according to the present invention, information extracted in the similarity test processes as shown in FIGS. 3A, 3B and 3C may be additionally stored in the data storage unit 70.

FIG. 4 is a flowchart illustrating a method of setting a driving order of gate lines according to an embodiment of the present invention.

Referring to FIG. 4, the method according to this embodiment includes selecting a gate line to become a reference (S1), comparing the voltage of a data signal corresponding to the selected gate line with the voltages of data signals corresponding to the other gate lines (S2), selecting the gate line having the voltage of a data signal with the highest similarity (i.e., the smallest similarity value) as a gate line to be driven next time (S3), and deciding whether the setting of the driving order of all the gate lines has been completed (S4).

For example, the order setting unit 60 first selects a gate line, which initially becomes a reference (S1). For example, in step S1, the order setting unit 60 may select the first gate line G1 positioned on the first horizontal line.

Subsequently, the order setting unit 60 compares the voltage of a data signal corresponding to the first gate line G1 with the voltages of data signals corresponding to the other gate lines (S2). In step S2, the order setting unit 60 extracts a similarity value for each gate line while performing the similarity test.

After the similarity values are extracted in step S2, the order setting unit 60 selects the gate line having the voltage of a data signal with the highest similarity (i.e., the gate line having the smallest similarity value), as a gate line to be driven next time (S3). Subsequently, the order setting unit 60 extracts similarity values, using the voltages of data signals corresponding to the other gate lines based on the next gate line (i.e., the gate lines of which driving order is not determined), and selects the gate line having the smallest similarity value as a gate line to be driven next time (S4). Actually, the order setting unit 60 determines the driving order of all the gate lines by repeating steps S1 to S4.

FIG. 5 is a flowchart illustrating a method of setting a driving order of gate lines according to another embodiment of the present invention.

Referring to FIG. 5, the method according to this embodiment includes selecting a gate line to become a reference (S100), extracting similarity values while sequentially comparing the voltage of a data signal corresponding to the selected gate line with the voltages of data signals corresponding to the other gate lines (S200), and selecting a corresponding gate line as a gate line to be driven next time when a similarity value of the gate line, which is no more than a predetermined reference value, is extracted (S300 and S400). The driving order of all the gate lines is set by repeating the process described above (S500).

For example, the order setting unit 60 first selects a gate line, which initially becomes a reference (S100). For example, in step S100, the order setting unit 60 may select the first gate line G1 positioned on the first horizontal line.

Subsequently, the order setting unit 60 extracts similarity values while sequentially comparing the voltage of a data signal corresponding to the first gate line G1 with the voltages of data signals corresponding to the other gate lines (S200). In a case where the extracted similarity value is set equal to or lower than a reference value, the gate line having the similarity value extracted therefrom is set as a gate line to be driven next time, and concurrently (e.g., simultaneously), the similarity test is stopped (S300 and S400).

If the next gate line is set, the order setting unit 60 extracts similarity values while sequentially comparing the voltages of data signals corresponding to the other gate lines, based on the set next gate line, and a corresponding gate line is set as a gate line to be driven next time when the extracted similarity value of the gate line is equal to or lower than the reference value (repeating steps S300, S400, and S200). Additionally, in a case where any similarity value, which is no more than the reference value, is not extracted, the gate line having the smallest similarity value extracted therefrom is set as a gate line to be driven next time. Actually, the order setting unit 60 sets the driving order of all the gate lines while repeating steps S100 to S400. If the setting of the driving order of all the gate lines is completed, the process described above is finished (S500).

In embodiments according to the present invention, the gate lines are divided into a plurality of groups, and the driving order of the gate lines may be set using gate lines included in each group.

More specifically, data signals supplied to adjacent gate lines are set similar to each other. Thus, each group is set to include at least two or more gate lines, and the similarity test is performed using gate lines included in each group. Subsequently, the driving order of the groups is set corresponding to the similarity test.

For example, the gate lines are divided into first to eighth groups each including a plurality of gate lines. Subsequently, one gate line is extracted from each of the first to eighth groups, and the similarity test is performed using the extracted gate lines. In this case, the driving order of the first to eighth groups is set. Subsequently, the gate lines are rearranged corresponding to the driving order of the first to eighth groups. Here, the gate lines included in the same group may be sequentially driven.

Additionally, in embodiments according to the present invention, the gate lines are divided into a plurality of groups, and the driving order of gate lines within a corresponding group may be set with respect to each group. For example, the gate lines are divided into a plurality of groups for each area in which the gate lines are arranged. Subsequently, if the setting of the driving order of gate lines included in one group is completed by the order setting unit, the driving order of gate lines included in the next group is set. In such a manner, driving orders of the gate lines may be sequentially set as a unit of groups.

In this case, if the setting of the driving order of gate lines included in the first group is completed, the setting of the driving order of gate lines included in the second group may be started, based on data on the gate line of driving order is finally set in the first group.

If the gate lines are divided in a plurality of groups, and the driving order of gate lines included in a corresponding group is set among the plurality of groups, it is possible to improve a search speed in a high-resolution, large-sized display device in which a large number of gate lines are arranged.

Further, the storing and/or writing of data on gate lines included in the previous group of which driving order has been completely set while the driving order of gate lines included in the next group is set, so that it is possible to reduce a time for which the driving order of the gate lines is set.

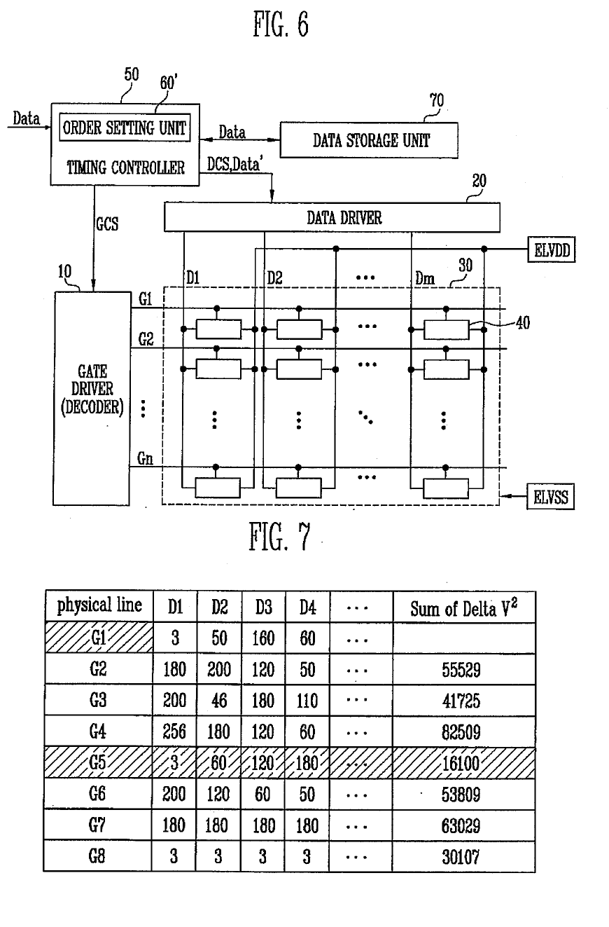

FIG. 6 is a diagram illustrating a display device according to another embodiment of the present invention. In FIG. 6, components identical or similar to those of FIG. 2 are designated by like reference numerals, and some repetitive detailed descriptions of the same or similar components will be omitted.

Referring to FIG. 6, the LUT 80 is removed in the display unit according to this embodiment. In this case, an order setting unit 60′ performs a similarity test (extraction of similarity values), using gray levels of data Data. That is, the order setting unit 60′ extracts gray level values (e.g., predetermined gray level values, for example, 1 to 256), corresponding to bits of the data Data stored in the data storage unit 70, and resets the driving order of the gate lines G1 to Gn, using the gray level values.

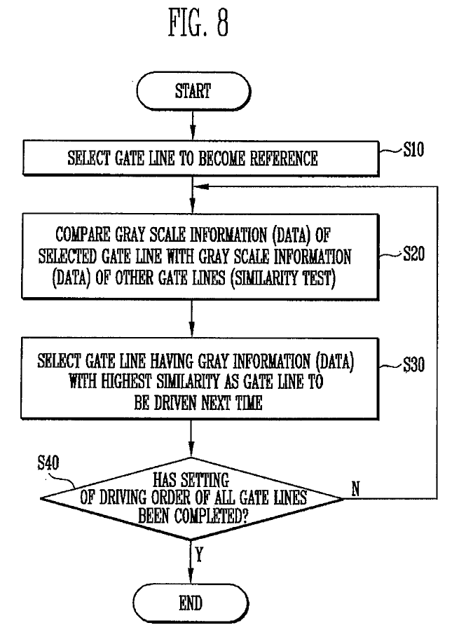

FIG. 7 is a diagram illustrating another embodiment of a method of determining a driving order of gate lines. For convenience of illustration, eight gate lines G1 to G8 will be shown in FIG. 7.

Referring to FIG. 7, gray level information is included in bits of a data Data stored in the data storage unit 70. The order setting unit 60′ performs a similarity test, using gray level information other than voltage information corresponding to the data Data.

The order setting unit 60′ sets a driving order of the gate lines G1 to G8, using the same method except that the order setting unit 60′ performs the similarity test using the gray level information other than the voltage information corresponding to the data Data. For example, the order setting unit 60′ sets the first gate line as a gate line which becomes a reference. Subsequently, the order setting unit 60′ subtracts gray level information of a comparison gate line from gray level information of the first gate line G1, and the subtracted gray level information is squared. Then, the squared gray level information is summed, thereby obtaining a similarity value. Accordingly, “55529” is obtained as a similarity value of the second gate line G2, “41725” is obtained as a similarity value of the third gate line G3, “82509” is obtained as a similarity value of the fourth gate line G4, “16100” is obtained as a similarity value of the fifth gate line G5, “58309” is obtained as a similarity value of the sixth gate line G6, “63029” is obtained as a similarity value of the seventh gate line G7, and “30107” is obtained as a similarity value of the eighth gate line G8. Among these gate lines, the fifth gate line G5 having the smallest similarity value is selected as a gate line to be driven next time.

The order setting unit 60′ sets the driving order of the gate lines G1 to G8 by repeating the process described above.

FIG. 8 is a flowchart illustrating a method of setting a driving order of gate lines according to still another embodiment of the present invention.

Referring to FIG. 8, the method according to this embodiment includes selecting a gate line to become a reference (S10), comparing gray level information of the selected gate line with gray level information of the other gate lines (S20), selecting a gate line having gray level information with the highest similarity (i.e., the lowest similarity value) as a gate line to be driven next time (S30), and deciding whether the setting of the driving order of all the gate lines has been completed.

For example, the order setting unit 60′ first selects a gate line which initially becomes a reference (S10). For example, in step 810, the order setting unit 60′ may select the first gate line G1 positioned on the first horizontal line.

Subsequently, the order setting unit 60′ compares gray level information of the first gate line G1 with gray level information of the other gate lines (S20). In step S20, the order setting unit 60′ extracts a similarity value for each gate line while performing the similarity test.

After the similarity values are extracted in step S20, the order setting unit 60′ selects a gate line having the voltage of a data signal with the highest similarity (e.g., a gate line with the smallest similarity value) as a gate line to be driven next time (S30). Subsequently, the order setting unit 60′ extracts similarity values, using gray level information of the other gate lines based on the next gate line (e.g., the gate lines of which driving order is not determined), and selects the gate line having the smallest similarity value as a gate line to be driven next time (S40). Actually, the order setting unit 60′ determines the driving order of all the gate lines by repeating steps S10 to S40.

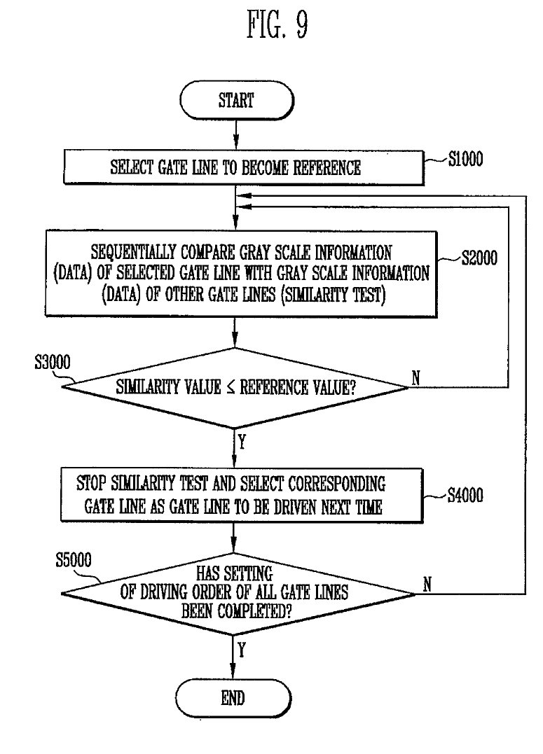

FIG. 9 is a flowchart illustrating a method of setting a driving order of gate lines according to still another embodiment of the present invention.

Referring to FIG. 9, the method according to this embodiment includes selecting a gate line to become a reference (S1000), extracting similarity values while sequentially comparing gray level information of the selected gate line with gray level information of the other gate lines (S2000), selecting a corresponding gate line as a gate line to be driven next time when a similarity value of the gate line, which is no more than a predetermined reference value, is extracted (S3000 and S4000). The driving order of all the gate lines is set while repeating the process described above (S5000).

For example, the order setting unit 60′ first selects a gate line which initially becomes a reference (S1000). For example, in step S10000, the order setting unit 60′ may select the first gate line G1 positioned on the first horizontal line.

Subsequently, the order setting unit 60′ extracts similarity values while sequentially comparing gray level information of the first gate line G1 with gray level information of the other gate lines (S2000). In this case, if the extracted similarity value is set equal to or lower than a reference value, the gate line having the similarity value extracted therefrom is set as a gate line to be driven next time, and concurrently (e.g., simultaneously), the similarity test is stopped (S3000 and S4000).

If the next gate line is set, the order setting unit 60′ extracts similarity values while sequentially comparing gray level information of the other gate lines, based on the next gate line, and sets a corresponding gate line as a gate line to be driven next time when the extracted similarity value of the gate line is equal to or lower than the reference value (repeating steps S3000, S4000 and S2000). Additionally, in a case where any similarity value, which is no more than the reference value, is not extracted, the gate line having the smallest similarity value extracted therefrom is set as a gate line to be driven next time. The order setting unit 60′ sets the driving order of all the gate lines while repeating steps S1000 to S4000. If the setting of the driving order of all the gate lines is completed, the process is finished (S5000).

In the methods described in FIGS. 8 and 9, the gate lines are divided into a plurality of groups, and the driving order of the gate lines may be set using gate lines included in each group.

Further, in the methods described in FIGS. 8 and 9, the gate lines are divided into a plurality of groups, and the driving order of gate lines included in a corresponding group may be set for each group.

Additionally, in FIGS. 8 and 9, similarity values are extracted using gray level information. Here, the gray levels generally include information of 256 gray levels or more, and accordingly, the calculation of the similarity values may be complicated. Thus, the gray level information is divided into some groups so that at least two or more gray level values are included in each group, and natural numbers which sequentially increase are assigned to the respective groups, thereby extracting similarity values.

For example, “1” is assigned to gray levels of 0 to 63, “2” is assigned to gray levels of 64 to 127, “3” is assigned to gray levels of 128 to 191, and “4” is assigned to gray levels of 192 to 255. Then, any one natural number among “1” to “4” is extracted, and accordingly, similarity values can be extracted through a simple calculation.

By way of summation and review, a display device generally expresses gray levels by supplying different data voltages respectively to pixels (analog driving). For example, in the analog driving, pixels are selected for each horizontal line while sequentially supplying a scan signal to scan lines, and a data signal corresponding to a gray level is supplied to the selected pixels, thereby controlling the luminance of the pixels.

However, in the analog driving, the voltage of the data signal is changed for each horizontal line, and hence power consumption is increased. Particularly, because the capacitance of data lines increases as a display panel becomes large in size and high in resolution, the increase in power consumption is deepened. Accordingly, it is required to find a plan for reducing power consumption while implementing a display device in an analog driving method.

In the display device and the driving method thereof according to embodiments of the present invention, there is provided an order setting unit which compares voltage values or gray level values corresponding to data as a unit of gate lines, and sets a driving order of the gate lines, based on the compared result. Particularly, when, the order setting unit comparing the voltage values or gray level values corresponding to the data as the unit of the gate lines, the order setting unit sets the driving order of the gate lines so that data signals of which power consumption is minimized can be consecutively written. Accordingly, in embodiments according to the present invention, it is possible to relatively reduce power consumption.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. A display device, comprising:
pixels at areas defined by gate lines and data lines;
a gate driver configured to selectively drive the gate lines;
a data driver configured to generate data signals set to various voltages, using data to be supplied to the gate lines, and to supply the data signals to the data lines;
a timing controller configured to control the gate driver and the data driver; and
an order setting unit configured to set a driving order of the gate lines by comparing information values of the gate lines.

2. The display device of claim 1, wherein the information values of the data are voltage values of data signals corresponding to the data.

3. The display device of claim 2, further comprising a lookup table configured to store the voltage values of the data signals corresponding to bits of the data.

4. The display device of claim 3, wherein the information values of the data are gray level values corresponding to the bits of the data.

5. The display device of claim 4, wherein the gray levels are divided into groups each comprising multiple ones of the gray level values, wherein natural numbers are assigned to corresponding ones of the groups in a sequentially increasing order.

6. The display device of claim 1, wherein the order setting unit is configured to:
detect similarities between the information values of the data supplied to other gate lines of the gate lines, based on information values of the data supplied to a first gate line of the gate lines; and
select a next gate line of the gate lines to which a next scan signal is to be supplied, wherein the next gate line has high similarity information values compared to the information values of the data supplied to the first gate line.

7. The display device of claim 6, wherein, when the similarity values are detected, the order setting unit is configured to:
obtain difference values between the information values of the data corresponding to a same data line of the data lines as the unit of the gate lines, based on the information values of the data supplied to the first gate line; and
extract similarity values by calculating a square of the difference values and calculating a sum of the square of the difference values as the unit of the gate lines.

8. The display device of claim 7, wherein the order setting unit is configured to select whichever one of the gate lines has a smallest similarity value for supplying the next scan signal.

9. The display device of claim 7, wherein the order setting unit is configured to select one of the gate lines that is arranged physically close to one of the first gate line to supply the next scan signal when a plurality of gate lines having a smallest similarity value exist.

10. The display device of claim 6, wherein the order setting unit is configured to set the driving order of all the gate lines by performing a similarity test on the gate lines, based on a specific gate line of the gate lines after the specific gate line is selected.

11. The display device of claim 6, wherein the first gate line is at a first horizontal line.

12. The display device of claim 1, wherein the order setting unit is configured to:
sequentially extract similarity values with the information values of the data supplied to other gate lines of the gate lines, based on the information values of the data supplied to a first gate line of the gate lines; and
select a specific gate line of the gate lines to which a next scan signal is to be supplied when the similarity value of the specific gate line of the gate lines is equal to or smaller than a reference value.

13. The display device of claim 12, wherein, when the specific gate line is selected, the order setting unit is configured to:
stop extracting the similarity values based on the first gate line; and
concurrently extract other similarity values with respect to the other gate lines of the gate lines, based on the specific gate line.

14. The display device of claim 1, wherein the gate lines are divided into a plurality of groups, and
wherein the order setting unit is configured to perform a similarity test by comparing the information values of the data with respect to one gate line of the gate lines in each group.

15. The display device of claim 14, wherein an order in which a gate signal is to be supplied is determined for each group according to the similarity test.

16. The display device of claim 14, wherein a scan signal is sequentially supplied to the gate lines in a same group.

17. The display device of claim 1, wherein the gate lines are divided into a plurality of groups, and
wherein the order setting unit is configured to perform a similarity test by comparing the information values of the data as a unit of gate lines of the gate lines in a corresponding group with respect to each of the groups.

18. The display device of claim 17, wherein the order setting unit is configured to set a next driving order of a next group of the groups after setting the driving order of gate lines with respect to one group of the groups.

19. The display device of claim 18, wherein the order setting unit is configured to start setting the driving order of the gate lines with respect to the next group, based on the information values of the data corresponding to a selected gate line of the gate lines of a completed group of the groups where the driving order of the gate lines has already been set.

20. The display device of claim 1, wherein the order setting unit is configured to:
generate a gate driving control signal corresponding to the driving order of the gate lines; and
supply the gate driving control signal to the gate driver.

21. The display device of claim 20, wherein the gate driver comprises a decoder configured to select one of the gate lines by outputting a scan signal corresponding to the gate driving control signal.

22. The display device of claim 1, further comprising a data storage unit configured to store the data.

23. A method of driving a display device, the method comprising:
setting a first gate line as a reference among a plurality of gate lines;
comparing information values of data assigned to the first gate line with information values of data assigned to other ones of the gate lines to calculate a compared result; and
selecting a second gate line of the gate lines to which a next scan signal is to be supplied, corresponding to the compared result,
wherein the information values of the data comprise voltage values of data signals to be supplied by the data or gray level values of the data.

24. The method of claim 23, wherein, whenever a driving order with respect to one of the gate lines is set, the one of the gate lines having the set driving order is designated a reference gate line, and the driving order of remaining ones of the gate lines is set by comparing the information values of the data corresponding to the reference gate line with the information values of the data assigned to the remaining ones of the gate lines.

25. The method of claim 24, further comprising supplying a data signal of the data signals to data lines according to the driving order of the gate lines.

26. The method of claim 23, wherein comparing the information values of the data assigned to the gate lines further comprises:
obtaining difference values between the information values of the data corresponding to a same data line as a unit of gate lines, based on the information values of the data supplied to the first gate line; and
extracting similarity values by calculating a square of the difference values and calculating a sum of the square of the difference values as the unit of the gate lines.

27. The method of claim 26, wherein selecting the second gate line further comprises selecting one of the gate lines that has a smallest similarity value.

28. The method of claim 26, wherein, comparing the information values of the data assigned to the first gate line with the information values of the data assigned to the other ones of the gate lines further comprises selecting a corresponding gate line of the gate lines as the second gate line when the similarity value of the corresponding gate line is equal to or lower than a reference value.
